(19) United States
(12) Patent Application Publication
(10) Pub. No.: US 2021/0131385 A1
(43) Pub. Date: May 6, 2021

(54) VALVE FLAP ASSEMBLY, VALVE ARRANGEMENT, EXHAUST SYSTEM, AND VEHICLE

(71) Applicant: Faurecia Emissions Control Technologies, Germany GmbH, Augsburg (DE)

(72) Inventors: Bastien Perichon, Augsburg (DE); Francois Fernand, Augsburg (DE); Otto Steinhauser, Augsburg (DE)

(21) Appl. No.: 17/069,924

(22) Filed: Oct. 14, 2020

(30) Foreign Application Priority Data
Oct. 30, 2019 (DE) 10 2019 129 356.1

(51) Int. Cl. F02M 26/16; F02M 35/10; F02M 26/33; F16K 3/06; F16K 3/02; F16K 3/22; F16K 31/52

(52) U.S. Cl. CPC F02M 26/16; F02M 35/10222; F02M 26/33; F16K 31/521; F16K 3/029; F16K 3/22; F16K 3/06

(57) ABSTRACT

A valve flap assembly for an exhaust-gas valve has a first valve flap provided for closing a first flow cross-section and a second valve flap provided for closing a second flow cross-section. The second valve flap is mounted for swiveling movement relative to the first valve flap. In addition, a valve arrangement for an exhaust system is presented which comprises such a valve flap assembly. Furthermore, an exhaust system for an internal combustion engine of a vehicle is presented, which comprises such a valve flap assembly and/or a valve arrangement. A vehicle having such an exhaust system is also disclosed.

### CROSS-REFERENCE TO RELATED APPLICATIONS

This application is a U.S. non-provisional application claiming the benefit of German Application No. 10 2019 129 356.1, filed on Oct. 30, 2019, which is incorporated herein by reference in its entirety.

### TECHNICAL FIELD

The disclosure relates to a valve flap assembly for an exhaust-gas valve, comprising a first swivel bearing element for swiveling the valve flap assembly about a swivel axis between a first position and a second position, a first valve flap for closing a first flow cross-section in the first position, and a second valve flap for closing a second flow cross-section in the second position.

The disclosure also relates to a valve arrangement for an exhaust system comprising a valve housing and such a valve flap assembly.

The disclosure further relates to an exhaust system for an internal combustion engine of a vehicle, comprising a valve flap assembly of the type initially mentioned and/or a valve arrangement of the type initially mentioned.

In addition, the disclosure relates to a vehicle having such an exhaust system.

### BACKGROUND

Vehicles, exhaust systems, valve arrangements, and valve flap assemblies are known from the prior art.

Valve arrangements and valve flap assemblies are usually exposed to comparatively high temperatures which are due to exhaust-gas flows conducted within an associated exhaust system. They must therefore be configured in a robust and in particular temperature resistant manner.

As exhaust systems also often include components which are only temperature-resistant up to a certain limit, valve arrangements and valve flap assemblies are often used to separate such components from hot exhaust-gas flows when necessary. It is particularly important that the valve arrangement and/or the valve flap assembly closes tightly, i.e. that it permits no or only slight leakage in the closed state. Otherwise, there is a risk that the components with limited temperature resistance will be damaged.

In this context, there is the problem, in particular with valve flap assemblies of the type initially mentioned, that the two valve flaps cannot be adjusted independently of each other to ensure a tight closure of the respectively assigned flow cross-section. In addition, such an adjustment mechanism would have to be configured in a temperature-resistant manner.

### SUMMARY

A valve flap assembly is provided that ensures a particularly tight closing of associated flow cross-sections. The valve flap assembly operates without leakage or at least with low leakage. At the same time, it is robust and temperature-resistant so as to function reliably even under the influence of hot exhaust-gas flows.

For this purpose a valve flap assembly is provided with a first swivel bearing element for swiveling the valve flap assembly about a swivel axis between a first position and a second position, a first valve flap for closing a first flow cross-section in the first position, and a second valve flap for closing a second flow cross-section in the second position, and wherein the second valve flap is mounted on the first valve flap for swiveling movement relative to the first valve flap.

In this context, the first flow cross-section and the second flow cross-section are to be understood as separate flow cross-sections.

In addition, a swiveling mounting of the second valve flap on the first valve flap means that the second valve flap is structurally attached to the first valve flap. Thus, the second valve flap can be swiveled relative to the first valve flap, wherein a relative movement between the two valve flaps is decisive. Therefore, the valve flaps can be adjusted independently of each other to the respectively assigned flow cross-section and thus ensure a tight closure thereof.

In this context, the swiveling mounting of the second valve flap in relation to the first valve flap may also compensate for dimensional deviations which occur within the valve flap assembly and/or a valve arrangement in which the valve flap assembly is installed. Such dimensional deviations may result from manufacturing and assembly tolerances. The compensation of dimensional deviations also contributes to a tight closing of the respective flow cross-sections.

Preferably, the valve flaps are made of sheet metal. They can be designed as stamped and bent parts. The valve flaps can thus be manufactured in a simple and cost-effective manner. In addition, it is thus possible to create valve flaps that are resistant to the high temperatures of an exhaust-gas flow.

When the valve flap assembly is used to influence exhaust-gas flows, it may also be referred to as an exhaust-gas flap.

For example, the first swivel bearing element is attached to the first or second valve flap.

The first valve flap and the second valve flap may be geometrically different. For example, the first valve flap and the second valve flap differ with regard to the area enclosed by a respectively assigned sealing contour. In simplified terms, the first valve flap can be larger than the second valve flap or vice versa. It is also possible that the valve flaps differ in terms of their shape. One of the valve flaps may be substantially round and the other substantially square or polygonal. Therefore, the valve flaps may be adapted independently of each other in terms of their geometry to the respective flow cross-section to be closed, and may thus selectively close the latter in a reliable manner.

Preferably, the first swivel bearing element is designed so as to be adapted to cooperate with a second swivel bearing element to swivel the valve flap assembly about the swivel axis. The first swivel bearing element and the second swivel bearing element thus form a swivel bearing via which the valve flap assembly is mounted. In particular, the second swivel bearing element is provided on a valve housing so that the valve flap assembly may be swiveled relative to this valve housing. This results in a reliable mounting and thus also in a reliable function of the valve flap assembly.

According to one variant, the first valve flap and/or the second valve flap has or have a curved sealing section, which is configured in particular as a spherical surface section. In the closed state, such sealing sections may form a line contact with a sealing contour at a flow cross-section to be closed. In this way, the flow cross-section can be closed in a reliable and leakage-free manner or with low leakage. The sealing contour at the flow cross-section is designed, for example, as a truncated cone envelope surface.

In an alternative, the first valve flap and/or the second valve flap has or have a flat sealing section which is arranged substantially in one plane. In other words, such a sealing section is a flat surface. It serves to form a surface contact together with a sealing contour arranged at a flow cross-section to be closed. The flow cross-section assigned to the sealing section can also be reliably closed therewith. In addition, flat sealing sections can be manufactured in a comparatively easy and cost-effective manner.

According to one embodiment, the valve flap assembly has a bearing pin, the second valve flap being mounted on the first valve flap via the bearing pin, in particular wherein the bearing pin is rigidly connected to the first valve flap or the second valve flap and is mounted for swiveling movement on the respective other of the first valve flap and the second valve flap. The second valve flap is thus mounted on the first valve flap in a simple and at the same time robust, in particular temperature-resistant manner. This results in a comparatively low manufacturing and assembly effort for the valve flap assembly.

The bearing pin may comprise a ball head, and the ball head may be accommodated in a corresponding ball cup which is provided on that valve flap of the first valve flap and the second valve flap on which the bearing pin is mounted for swiveling movement. The ability of the second valve flap for swiveling movement with respect to the first valve flap can thus be ensured in a simple manner. In particular, the ball head is arranged in the ball cup without any intermediate elements. This ensures a high temperature resistance of the joint formed by the ball cup and the ball head. Furthermore, such a joint can be manufactured in a comparatively easy and cost-effective manner.

Advantageously, the bearing pin is supported on the first valve flap and/or the second valve flap via an elastically and/or plastically deformable bearing component, in particular on the valve flap on which the bearing pin is mounted for swiveling movement. It shall be understood that the elastic and/or plastic deformability means a possible deformation during the intended operation. If the bearing component is purely plastically deformable, the first valve flap and the second valve flap can be transferred from an initial position to a new relative position. This new relative position is then held. In particular, the first valve flap and the second valve flap do not return to the initial position. This behavior of the bearing component is particularly suitable for compensating dimensional deviations within the valve flap assembly or a valve arrangement, resulting from manufacturing and/or assembly tolerances. In contrast to a purely elastic deformation of the bearing component, a purely plastic deformation does not require the dimensional deviation to be compensated by a new deformation each time the valve flap assembly is actuated. Therefore, the valve flap assembly including a plastically, in particular purely plastically deformable bearing component is a particularly low-wear and durable component.

Preferably, the bearing component comprises a wire mesh, a wire cloth and/or a shape memory material. In the context of the present disclosure, an enumeration of several alternatives with “and/or” shall be understood as a disclosure of any combination of the alternatives. The bearing component thus comprises a wire mesh and/or a wire cloth and/or a shape memory material. Such bearing components are substantially purely plastically deformable during operation of the valve flap assembly. They therefore do not return to their initial position after deformation. In this way, dimensional deviations can be compensated for particularly effectively. In addition, the materials mentioned are comparatively simple and cost-effective. They also have a high heat resistance.

The valve flap assembly may have a bearing housing, wherein the bearing component is arranged within the bearing housing. The bearing housing is attached in particular to the valve flap on which the bearing component is supported. Preferably, the bearing housing is made of sheet metal. In this way, the bearing component is simply and reliably held on an associated valve flap.

Preferably, the bearing component surrounds the bearing pin in the peripheral direction with respect to the center axis of the bearing pin, in particular in the peripheral direction in the region of the ball head. Therefore, the bearing component may reliably support a swiveling movement of the second valve flap relative to the first valve flap in all directions.

In addition, a valve arrangement for an exhaust system is provided that comprises a valve housing and a valve flap assembly according to the disclosure, wherein the valve flap assembly is adapted for swivel movement relative to the valve housing about the swivel axis, in particular wherein the second swivel bearing element is provided on the valve housing. The valve housing may have at least a first and a second flow cross-section, which are adapted to be selectively closed by the valve flap assembly. The two flow cross-sections can thus be sealed leakage-free or at least with low leakage. The valve housing may be configured in one piece or in several pieces.

The features and advantages mentioned for the valve flap assembly apply equally to the valve arrangement and vice versa.

The valve arrangement may also be referred to as an exhaust-gas valve, an exhaust-gas flap arrangement or an exhaust-gas flap valve.

In addition, an exhaust system for an internal combustion engine of a vehicle is provided, which comprises a valve flap assembly according to the disclosure and/or a valve arrangement according to the disclosure. In such an exhaust system, exhaust-gas flows can be reliably controlled by the valve flap assembly and/or the valve arrangement. This is done without leakage or at least with low leakage. In particular, such components of the exhaust system which have only a limited temperature resistance can be reliably protected against hot exhaust-gas flows.

The features and advantages mentioned for the valve flap assembly and/or the valve arrangement apply equally to the exhaust system and vice versa.

The exhaust system may include a heat recovery system for recovering heat from exhaust gas, and an exhaust gas recirculation system for introducing exhaust gas into an intake tract, and the valve flap assembly may be a component of the heat recovery system and/or the exhaust gas recirculation system. In this context, an exhaust gas recirculation system is also referred to as Exhaust Gas Recirculation (EGR). In technical terminology, a heat recovery system is also referred to as an Exhaust Heat Recovery System (EHRS). The valve flap assembly may be used to protect the heat recovery system and/or the exhaust gas recirculation system against exhaust-gas flows the temperature of which exceeds the resistance of the heat recovery system and/or the exhaust gas recirculation system. This protection is particularly reliable as the valve flap assembly operates in a leakage-free manner or at least with low leakage.

In addition, a vehicle having an exhaust system is provided according to the disclosure. As in such a vehicle, a heat recovery system present within the exhaust system and/or an exhaust gas recirculation system provided there is protected against temperatures which are too high, the exhaust system functions particularly reliably and has a long service life. This also applies to a vehicle equipped therewith.

The features and advantages mentioned for the valve flap assembly, the valve arrangement and/or the exhaust system apply equally to the vehicle and vice versa.

### BRIEF DESCRIPTION OF THE DRAWINGS

The disclosure is explained below with reference to various example embodiments which are shown in the attached drawings in which:

FIG. 1 shows a vehicle according the disclosure having an exhaust system according to the disclosure which comprises a valve arrangement according to the disclosure and a valve flap assembly according to the disclosure,

FIG. 2 shows a section of the exhaust system from FIG. 1,

FIG. 3 shows a detail III of the exhaust system from FIG. 2,

FIG. 4 shows the valve flap assembly of the exhaust system according to FIGS. 1 to 3 in an isolated representation,

FIG. 5 shows a representation corresponding to FIG. 3, the valve flap assembly being configured according to an alternative embodiment, and

FIG. 6 shows a representation corresponding to FIG. 5, wherein dimensional deviations are compensated by the valve flap assembly.

### DETAILED DESCRIPTION

Lists having a plurality of alternatives connected by “and/or”, for example “A, B and/or C” are to be understood to disclose an arbitrary combination of the alternatives, i.e. the lists are to be read as “A and/or B and/or C”. The same holds true for listings with more than two items.

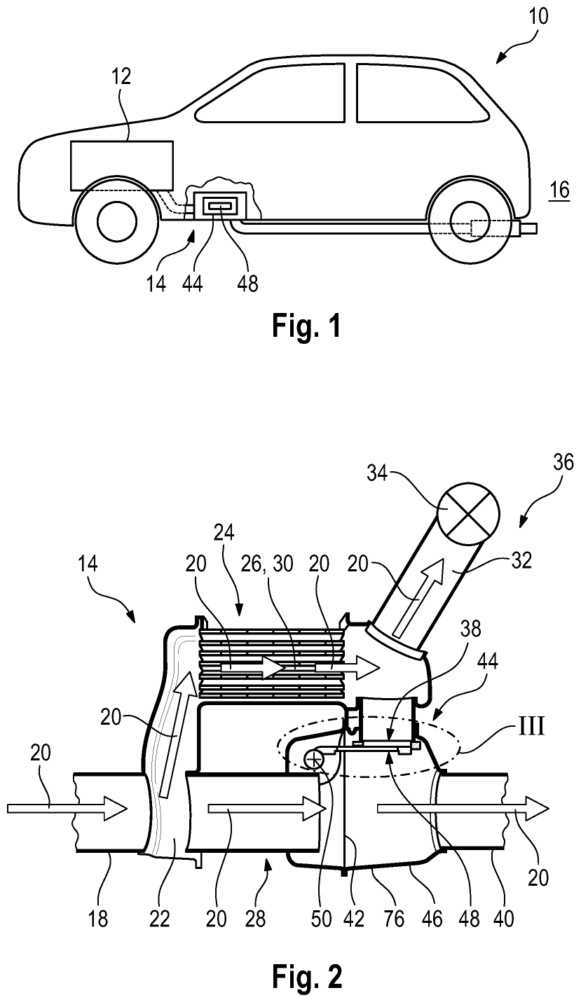

FIG. 1 shows a vehicle 10 having an internal combustion engine 12 coupled to an exhaust system 14. The purpose of the exhaust system 14 is to direct exhaust gas generated by the internal combustion engine 12 to an environment 16.

As shown in FIG. 2, the exhaust system 14 comprises an engine-side exhaust-gas line 18 in the form of an engine-side exhaust-gas pipe through which an exhaust-gas flow 20, symbolized by several arrows, can be introduced into the exhaust system 14.

At an end of the engine-side exhaust-gas line 18 facing away from the internal combustion engine 12, a branching point 22 is also provided, via which a first partial flow of the exhaust-gas flow 20 can be directed into a first branch 24 of the exhaust system 14. It is equipped with a heat exchanger 26.

A second partial flow of the exhaust-gas flow 20 can be directed by the branching point 22 into a second branch 28 of the exhaust system 14, which is configured without a heat exchanger.

Here, the heat exchanger 26 serves to recover heat from the exhaust-gas flow 20, more precisely from the partial flow in the first branch 24, and thus forms a heat recovery system 30.

Starting from the first branch 24, the exhaust-gas flow 20 can be selectively recirculated into an intake tract of the internal combustion engine 12 via an exhaust gas recirculation line 32 and an exhaust gas recirculation valve 34. In this respect, the exhaust gas recirculation line 32 and the exhaust gas recirculation valve 34 form an exhaust gas recirculation system 36.

Alternatively or additionally, the exhaust-gas flow from the first branch 24 can be directed via a first flow cross-section 38 into a downstream exhaust-gas line 40 in the form of a downstream exhaust-gas pipe. From there, the exhaust-gas flow 20 can be directed towards the environment 16.

Starting from the second branch 28, the exhaust-gas flow 20 can also be directed into the downstream exhaust-gas line 40 via a second flow cross-section 42.

The first branch 24 and the second branch 28 run substantially parallel both in terms of flow and geometrically.

In addition, a valve arrangement 44 is provided which connects the first branch 24, the second branch 28 and the downstream exhaust-gas line 40.

It comprises a valve housing 46 and a valve flap assembly 48.

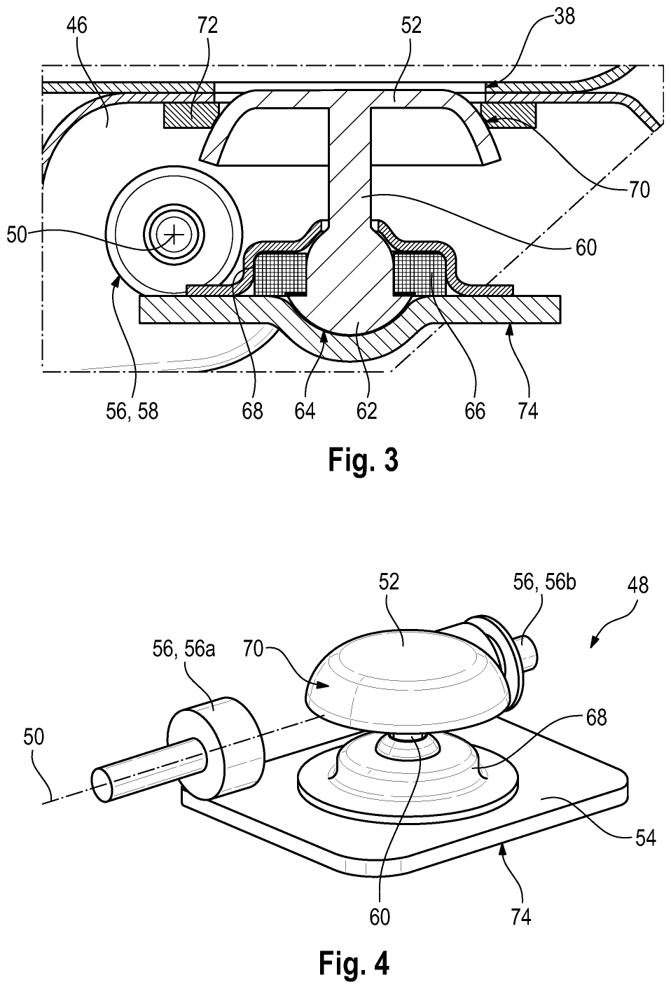

FIG. 3 shows in detail the valve arrangement 44 including the valve body 46 and the valve flap assembly 48 according to a first embodiment. In FIG. 3, the valve flap assembly 48 is in a first position. In addition, FIG. 4 shows the valve flap assembly 48 in a perspective view.

The valve flap assembly 48 comprises a first valve flap 52, a second valve flap 54, a first swivel bearing element 56, and a bearing pin 60.

In the embodiment shown, the first swivel bearing element 56 is attached to the second valve flap 54. It comprises the swivel bearing element sections 56a and 56b, which are fastened to the second valve flap 54 offset to each other.

A second swivel bearing element 58 is provided on the valve housing 46, the first swivel bearing element 56 and the second swivel bearing element 58 together forming a swivel bearing having a swivel axis 50.

In the embodiment shown in FIGS. 3 and 4, the bearing pin 60 is rigidly connected to the first valve flap 52.

At its end facing away from the first valve flap 52, the bearing pin 60 has a ball head 62. The latter is accommodated in a corresponding ball cup 64 which is provided on the second valve flap 54.

The ball head 62 and the ball cup 64 thus form a ball joint.

In addition, the bearing pin 60 is supported on the second valve flap 54 via a bearing component 66 which is substantially purely plastically deformable and is designed as a wire mesh in the embodiment shown.

In the region of the ball head 62, the bearing component 66 surrounds the bearing pin 60 in the peripheral direction with respect to its center axis and is arranged in a bearing housing 68.

The bearing housing is attached to the second valve flap 54.

It can be seen from FIGS. 3 and 4 that the two valve flaps 52, 54 are geometrically different and are thus adapted to the respectively assigned flow cross-section 38, 42 to be closed.

More precisely, the first valve flap 52 is round and the second valve flap 54 is substantially rectangular. Furthermore, the second valve flap 54 is larger than the first valve flap 52.

In this context, the first valve flap 52 has a sealing section 70 which is designed as a spherical surface section. To close the first flow cross-section 38, it cooperates with an associated sealing contour 72, which is provided in the region of the flow cross-section 38 on the valve housing 46.

The sealing contour 72 is shaped to as to be substantially complementary to the sealing section 70.

When the first flow cross-section 38 is closed by the first valve flap 52, the sealing section 70 and the sealing contour 72 form a line contact. The sealing contour 72, for example, has the shape of a truncated cone envelope surface.

The sealing section 74 of the second valve flap 54 is flat and is arranged substantially in one plane. An associated sealing contour 76, which is provided in the region of the second flow cross-section 42 on the valve body 46, is accordingly also flat and is arranged substantially in one plane.

The sealing section 74 and the sealing contour 76 thus form a surface contact when the second flow cross-section 42 is closed by the second valve flap 54.

The valve flap assembly 48 is adapted to be swiveled relative to the valve housing 46 about the swivel axis 50 between a first position and a second position.

In this way, the valve flap assembly 48 closes the first flow cross-section 38 in the first position and the second flow cross-section 42 in the second position.

Intermediate positions of the valve flap assembly 48 are of course also conceivable. In an intermediate position, neither the first flow cross-section 38 nor the second flow cross-section 42 is completely closed.

Via the position of the valve flap assembly 48 and of the exhaust gas recirculation valve 34, it is thus possible to purposefully set which proportion of the exhaust-gas flow 20 is directed through the heat recovery system 30 and which proportion is directed into the exhaust gas recirculation system 36. The valve flap assembly 48 can thus also be regarded as a component of the heat recovery system 30 and of the exhaust gas recirculation system 36.

Furthermore, the two valve flaps 52, 54 are mounted to each other for swiveling movement via the bearing pin 60. The first valve flap 52 can thus be swiveled in relation to the second valve flap 54 and vice versa.

The fact that the first valve flap 52 and the second valve flap 54 can be swiveled relative to each other can be used to compensate for dimensional deviations resulting from the manufacture and/or assembly of components of the exhaust system 14 or of the valve arrangement 44. In other words, the first flow cross-section 38 and the second flow cross-section 42 can be reliably closed in a leakage-free manner or with low-leakage even if dimensional deviations occur.

In this context, the first valve flap 52 can be swiveled relative to the second valve flap 54 under substantially purely plastic deformation of the bearing component 66.

The plastic deformation of the bearing component 66 ensures that the first valve flap 52 and the second valve flap 54 also remain in this swiveled state until further adjustment of the valve flap assembly 48 might be necessary. Thus, an adjusting movement takes place only once or a few times, thus avoiding wear. In addition, it is also possible to compensate for any new dimensional deviations occurring during operation of the exhaust system 14.

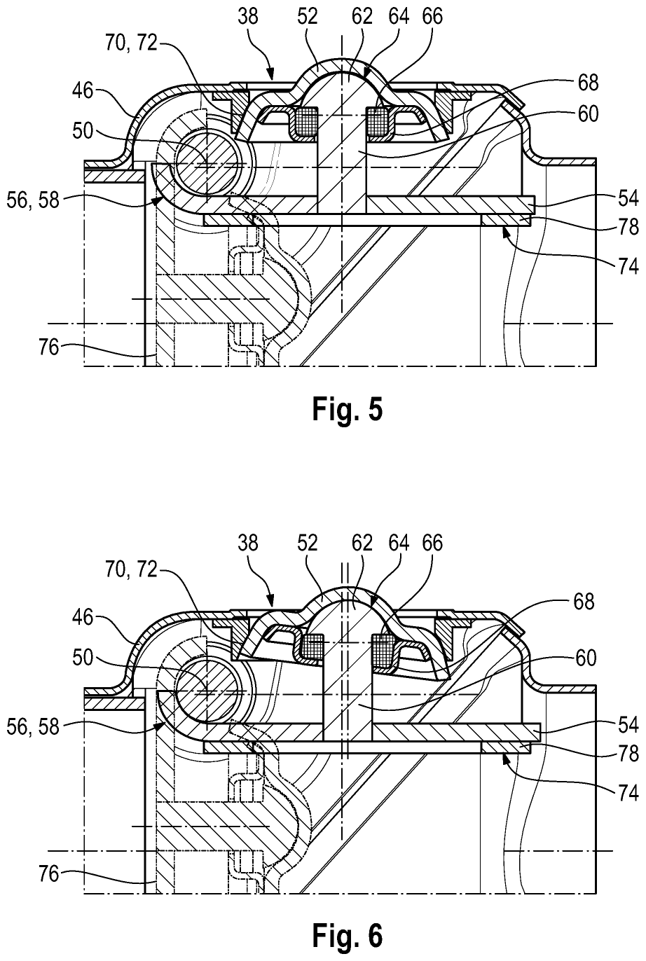

FIGS. 5 and 6 show a further embodiment of the valve arrangement. It substantially corresponds to that of the first embodiment, so that only the differences are discussed below. Identical and functionally identical parts are marked with the same reference numerals.

The valve arrangement 44 of the second embodiment differs from the first embodiment in that the bearing pin 60 is now rigidly connected to the second valve flap 54 and is mounted for swiveling movement on the first valve flap 52.

For this purpose, a ball cup 64 is now formed on the first valve flap 52. The ball head 62 is accordingly provided at the end of the bearing pin 60 which faces the first valve flap 52.

In addition, in the second embodiment, the sealing section 74 of the second valve flap 54 is formed by a sealing element 78, which is fastened to the second valve flap 54.

An overview of FIGS. 5 and 6 also illustrates how the valve flap assembly 48 may compensate for dimensional deviations.

An initial situation may be shown in FIG. 5. Compared to this initial situation, the first valve flap 52 is swiveled in FIG. 6 by the ball joint formed by the ball head 62 and the ball cup 64 in order to be able to seal the first flow cross-section 38 in a reliable and substantially leakage-free manner despite the dimensional deviations that have occurred.

In this connection, the bearing component 66 was plastically deformed.

FIGS. 5 and 6 also show with dotted lines the second position of the valve flap assembly 48.

Although various embodiments have been disclosed, a worker of ordinary skill in this art would recognize that certain modifications would come within the scope of this disclosure. For that reason, the following claims should be studied to determine the true scope and content of this disclosure.

1. A valve flap assembly for an exhaust-gas valve, comprising
a first swivel bearing element for swiveling the valve flap assembly about a swivel axis between a first position and a second position,
a first valve flap for closing a first flow cross-section in the first position, and
a second valve flap for closing a second flow cross-section in the second position, wherein the second valve flap is mounted on the first valve flap for swiveling movement relative to the first valve flap.

2. The valve flap assembly according to claim 1, wherein the first valve flap and the second valve flap are geometrically different.

3. The valve flap assembly according to claim 1, wherein the first swivel bearing element is configured to be adapted to cooperate with a second swivel bearing element to swivel the valve flap assembly about the swivel axis.

4. The valve flap assembly according to claim 1, wherein at least one of the first valve flap and the second valve flap has a curved sealing section.

5. The valve flap assembly according to claim 4, wherein the curved sealing section is configured as a spherical surface section.

6. The valve flap assembly according to claim 1, wherein at least one of the first valve flap and the second valve flap has a flat sealing section which is substantially arranged in one plane.

7. The valve flap assembly according to claim 1, wherein the valve flap assembly has a bearing pin, wherein the second valve flap is mounted on the first valve flap via the bearing pin.

8. The valve flap assembly according to claim 7, wherein the bearing pin is rigidly connected to the first valve flap or the second valve flap and is mounted for swiveling movement on a respective other of the first valve flap and the second valve flap.

9. The valve flap assembly according to claim 7, wherein the bearing pin has a ball head and in that the ball head is accommodated in a corresponding ball cup provided on that valve flap of the first valve flap and the second valve flap on which the bearing pin is mounted for swiveling movement.

10. The valve flap assembly according to claim 7, wherein the bearing pin is supported on at least one of the first valve flap and on the second valve flap via at least one of an elastically deformable bearing component and plastically deformable bearing component.

11. The valve flap assembly according to claim 10, wherein the at least one of the elastically deformable bearing component and the plastically deformable bearing component is on the valve flap on which the bearing pin is mounted for swiveling movement.

12. The valve flap assembly according to claim 10, wherein the at least one of the elastically deformable bearing component and the plastically deformable bearing component comprises at least one of a wire mesh, a wire cloth and a shape memory material.

13. The valve flap assembly according to claim 10, wherein the valve flap assembly has a bearing housing, wherein the at least one of the elastically deformable bearing component and the plastically deformable bearing component is arranged within the bearing housing.

14. The valve flap assembly according to claim 10, wherein the at least one of the elastically deformable bearing component and the plastically deformable bearing component surrounds the bearing pin in a peripheral direction with respect to a center axis of the bearing pin.

15. A valve arrangement for an exhaust system, comprising a valve housing and the valve flap assembly according to claim 1, wherein the valve flap assembly is adapted to swivel about the swivel axis with respect to the valve housing.

16. The valve arrangement according to claim 15, wherein a second swivel bearing element is provided on the valve housing.

17. An exhaust system for an internal combustion engine of a vehicle, comprising:
a valve flap assembly having a first swivel bearing element for swiveling the valve flap assembly about a swivel axis between a first position and a second position, a first valve flap for closing a first flow cross-section in the first position, and a second valve flap for closing a second flow cross-section in the second position, wherein the second valve flap is mounted on the first valve flap for swiveling movement relative to the first valve flap.

18. The exhaust system according to claim 17, including a heat recovery system for the recovery of heat from exhaust gas, and an exhaust gas recirculation system for introducing exhaust gas into an intake tract, and in that the valve flap assembly is a component of the heat recovery system and/or the exhaust gas recirculation system.

19. A vehicle comprising:
an exhaust system comprising a valve flap assembly having a first swivel bearing element for swiveling the valve flap assembly about a swivel axis between a first position and a second position, a first valve flap for closing a first flow cross-section in the first position, and a second valve flap for closing a second flow cross-section in the second position, wherein the second valve flap is mounted on the first valve flap for swiveling movement relative to the first valve flap.
